(19) United States
(12) Patent Application Publication
(10) Pub. No.: US 2012/0212959 A1
(43) Pub. Date: Aug. 23, 2012

(54) LIGHTING DEVICE

(75) Inventors: Michinobu INOUE, Kanagawa-ken (JP); Izuru Komatsu, Kanagawa-ken (JP); Yasuhide Okada, Kanagawa-ken (JP); Daigo Suzuki, Kanagawa-ken (JP); Kumiko Ioka, Chiba-ken (JP); Kazuki Tateyama, Kanagawa-ken (JP)

(73) Assignee: KABUSHIKI KAISHA TOSHIBA, Tokyo (JP)

(21) Appl. No.: 13/397,036

(22) Filed: Feb. 15, 2012

(30) Foreign Application Priority Data
Feb. 21, 2011 (JP) 2011-034293
Sep. 9, 2011 (JP) 2011-197722

(51) Int. Cl. F21V 3/00; F21V 7/00; F21V 29/00

(52) U.S. Cl. 362/249.01; 362/311.06; 362/310

(57) ABSTRACT

According to one embodiment, a lighting device includes a body section, a light source, a globe, and a heat transfer section. The light source is provided on one end portion of the body section. The light source includes a light emitting element. The globe is provided so as to cover the light source. The heat transfer section in thermal contacts with at least one of an inner surface of the globe and a heat dissipation surface on the end portion side of the body section.

### CROSS-REFERENCE TO RELATED APPLICATIONS

This application is based upon and claims the benefit of priority from the prior Japanese Patent Application No. 2011-034293, filed on Feb. 21, 2011, and the prior Japanese Patent Application No. 2011-197722, filed on Sep. 9, 2011; the entire contents of which are incorporated herein by reference.

### FIELD

Embodiments described herein relate generally to a lighting device.

### BACKGROUND

Recently, instead of incandescent lamps (filament lamps), lighting devices using light emitting diodes (LED) as a light source have been put to practical use.

Lighting devices based on light emitting diodes have long lifetime and can reduce power consumption. Hence, such lighting devices are expected to replace existing incandescent lamps.

In such lighting devices based on light emitting diodes, heat generated in the light source is dissipated to the outside through the body section. Thus, lighting devices including a body section capable of improving heat dissipation performance have been proposed.

However, there is a limitation on the heat dissipation through only the body section. Thus, further improvement in heat dissipation performance has been demanded.

### BRIEF DESCRIPTION OF THE DRAWINGS

FIGS. 1A and 1B are schematic views for illustrating a lighting device according to a first embodiment;

FIG. 2 is a schematic perspective view for illustrating a heat transfer section;

FIGS. 3A and 3B are schematic views for illustrating the relationship between the shape of the globe and the light distribution angle;

FIG. 4 is a graph for illustrating the reflectance of the reflective layer;

FIGS. 5A to 5D are schematic views for illustrating heat dissipation in the lighting device;

FIGS. 6A and 6B are schematic perspective views for illustrating lighting devices according to a second embodiment;

FIGS. 7A and 7B are schematic view and graph for illustrating a heat transfer section including an opening;

FIG. 8 is a schematic partial sectional view for illustrating an opening according to an alternative embodiment;

FIG. 9 is a schematic graph for illustrating the thickness dimension of the heat transfer section;

FIGS. 10A to 10D are schematic views for illustrating connecting portions between the heat transfer section and the substrate;

FIGS. 11A and 11B are schematic views for illustrating a projection provided on the surface of the heat transfer section; and

FIGS. 12A and 12B are schematic views for illustrating the arrangement of the heat transfer section 59 and the light emitting element 3b in plan view;

### DETAILED DESCRIPTION

In general, according to one embodiment, a lighting device includes a body section, a light source, a globe, and a heat transfer section. The light source is provided on one end portion of the body section. The light source includes a light emitting element. The globe is provided so as to cover the light source. The heat transfer section in thermal contacts with at least one of an inner surface of the globe and a heat dissipation surface on the end portion side of the body section.

Embodiments will now be illustrated with reference to the drawings. In the drawings, similar components are labeled with like reference numerals, and the detailed description thereof is omitted appropriately.

### First Embodiment

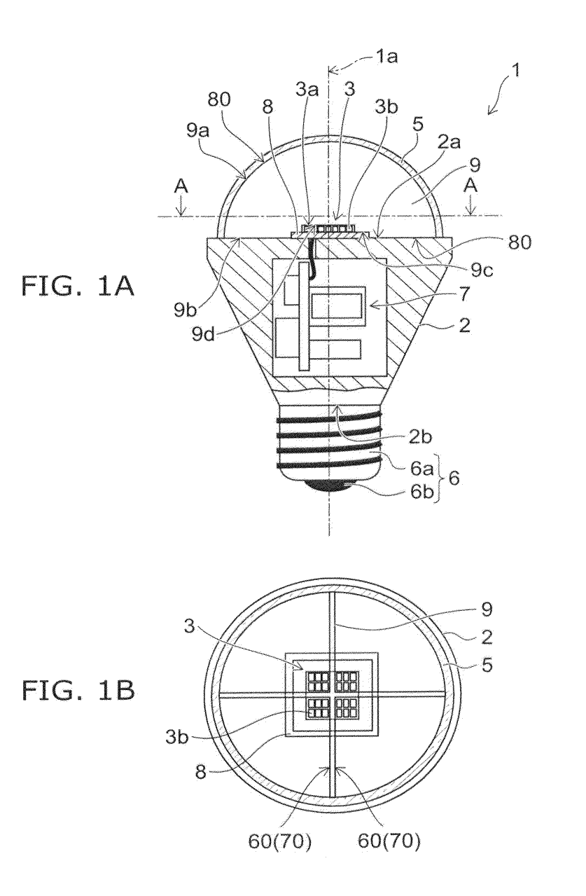

FIGS. 1A and 1B are schematic views for illustrating a lighting device according to a first embodiment.

More specifically, FIG. 1A is a schematic partial sectional view of the lighting device. FIG. 1B is a sectional view taken in the direction of arrows A-A in FIG. 1A.

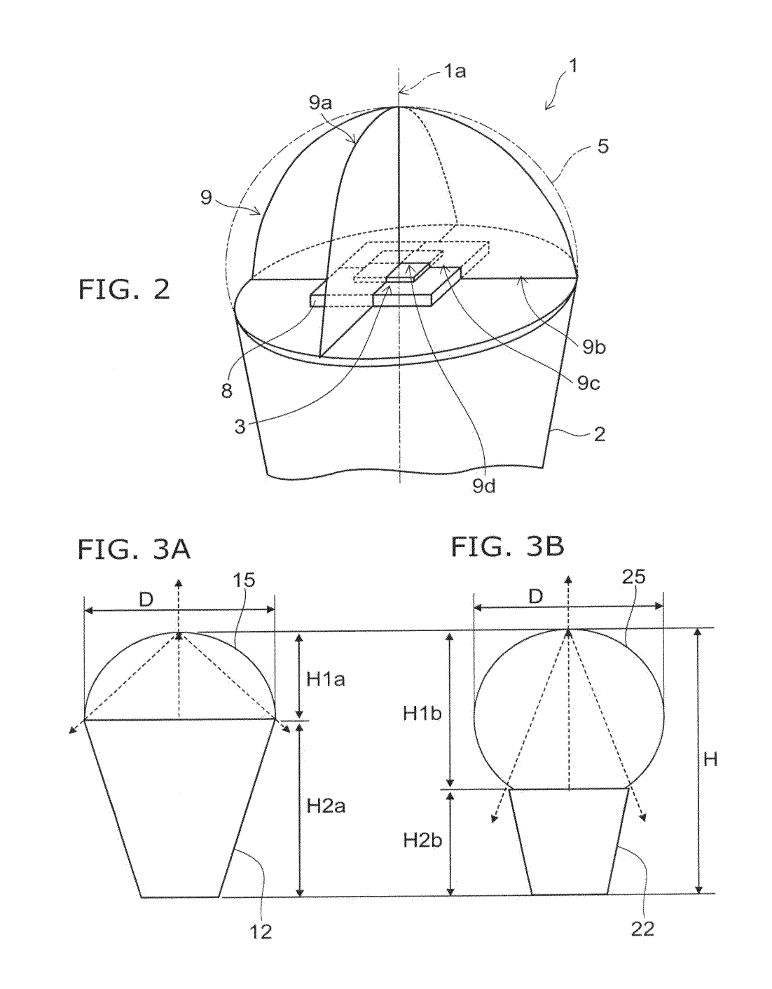

FIG. 2 is a schematic perspective view for illustrating a heat transfer section.

As shown in FIG. 1A, the lighting device 1 includes a body section 2, a light source 3, a globe 5, a base section 6, a control section 7, and a heat transfer section 9.

The body section 2 can be shaped so that, for instance, the cross-sectional area in the direction perpendicular to the axial direction gradually increases from the base section 6 side to the globe 5 side. However, the shape of the body section 2 is not limited thereto. For instance, the shape of the body section 2 can be appropriately modified depending on the size of e.g. the light source 3, the globe 5, and the base section 6. In this case, the shape of the body section 2 can be made approximate to the shape of the neck portion of an incandescent lamp. This can facilitate replacement for existing incandescent lamps.

The body section 2 can be formed from e.g. a material having high thermal conductivity. The body section 2 can be formed from e.g. a metal such as aluminum (Al), copper (Cu), and an alloy thereof. However, the material of the body section 2 is not limited thereto. The body section 2 can also be formed from e.g. an inorganic material such as aluminum nitride (AlN) and alumina (Al₂O₃), or an organic material such as high thermal conductivity resin.

The light source 3 is provided at the center of one end portion 2a of the body section 2. The radiation surface 3a of the light source 3 is provided perpendicular to the central axis 1a of the lighting device 1, and radiates light primarily in the axial direction of the lighting device 1. The light source 3 can be configured to include e.g. a plurality of light emitting elements 3b. However, the number of light emitting elements 3b can be appropriately modified. One or more light emitting elements 3b can be provided depending on e.g. the purpose of the lighting device 1 and the size of the light emitting element 3b.

The light emitting element 3b can be e.g. a so-called self-emitting element such as a light emitting diode, organic light emitting diode, and laser diode. In the case of providing a plurality of light emitting elements 3b, they can be provided in a regular arrangement pattern such as a matrix, staggered, and radial pattern, or in an arbitrary arrangement pattern.

The globe 5 is provided on one end portion 2a of the body section 2 so as to cover the light source 3. The globe 5 can be configured to include a curved surface protruding in the radiation direction of light. The globe 5 has translucency so that the light radiated from the light source 3 can be emitted to the outside of the lighting device 1. The globe 5 can be formed from a translucent material. For instance, the globe 5 can be formed from e.g. glass, transparent resin such as polycarbonate, and translucent ceramic. As necessary, a diffusing agent or phosphor can be applied to the inner surface of the globe 5. Alternatively, a diffusing agent or phosphor can be contained in the globe 5 (a diffusing agent or phosphor can be blended into the translucent material).

The globe 5 can be integrally molded, or can be formed by bonding separate parts at the time of assembly. By bonding separate parts at the time of assembly, assemblability can be improved. Furthermore, in the case of bonding separate parts at the time of assembly, the bonded position is preferably aligned with the heat transfer section 9.

The base section 6 is provided on the end portion 2b of the body section 2 opposite from the side provided with the globe 5. The base section 6 can be configured to have a shape attachable to the socket for receiving an incandescent lamp. The base section 6 can be configured to have a shape similar to e.g. E26 and E17 specified by the JIS standard. However, the base section 6 is not limited to the shapes illustrated above, but can be appropriately modified. For instance, the base section 6 can also be configured to have pin-shaped terminals used for a fluorescent lamp, or an L-shaped terminal used for a ceiling hook.

The base section 6 can be formed from e.g. a conductive material such as metal. Alternatively, the portion electrically connected to the external power supply can be formed a conductive material such as metal, and the remaining portion can be formed from e.g. resin.

The base section 6 illustrated in FIG. 1A includes a cylindrical shell portion 6a having a screw thread, and an eyelet portion 6b provided on the end portion of the shell portion 6a opposite from the end portion provided on the body section 2. To the shell portion 6a and the eyelet portion 6b, the control section 7 described later is electrically connected. This enables the control section 7 to be electrically connected to the external power supply, not shown, through the shell portion 6a and the eyelet portion 6b. Here, in the case where the body section 2 is formed from e.g. metal, an insulating section formed from e.g. an adhesive can be provided between the body section 2 and the base section 6.

The control section 7 is provided in the space formed inside the body section 2. Here, an insulating section, not shown, for electrical insulation can be appropriately provided between the body section 2 and the control section 7.

The control section 7 can be configured to include a lighting circuit for supplying electrical power to the light source 3. In this case, the lighting circuit can be configured, for instance, to convert the AC 100 V commercial power to DC and to supply it to the light source 3. Furthermore, the control section 7 can also be configured to include a dimming circuit for dimming the light source 3. Here, in the case of providing a plurality of light emitting elements 3b, the dimming circuit can be configured to perform dimming for each light emitting element, or for each group of light emitting elements.

A substrate 8 is provided between the light source 3 and the body section 2.

The substrate 8 can be formed from e.g. a material having high thermal conductivity. The substrate 8 can be formed from e.g. a metal such as aluminum (Al), copper (Cu), and an alloy thereof. A wiring pattern, not shown, can be formed on the surface of the substrate 8 via an insulating layer. This facilitates electrically connecting the light source 3 to the control section 7 via the wiring pattern, not shown. Furthermore, heat generated in the light source 3 can be easily dissipated to the outside through the substrate 8 and the body section 2. Furthermore, as described later, the heat generated in the light source 3 can be easily dissipated to the outside through the substrate 8, the heat transfer section 9, and the globe 5. In this case, the substrate 8 may be configured so that a wiring pattern is formed on the surface of a ceramic, glass-epoxy, composite-epoxy base material. The detail of the heat dissipation through the substrate 8, the heat transfer section 9, and the globe 5 is described later.

Here, the heat generated in the light source 3 is dissipated to the outside through the substrate 8 and the body section 2.

However, in the case of e.g. increasing electrical power inputted to the light source 3 to further increase the luminous flux of the lighting device 1, only the heat dissipation through the body section 2 may fail to achieve a sufficient cooling effect.

Furthermore, in the case where the light source 3 is made of light emitting elements 3b, the problem is that the light distribution angle is narrower than that of the incandescent lamp. In this case, the light distribution angle can be expanded by making the shape of the globe 5 close to a whole sphere. However, as described later, if the shape of the globe 5 is made close to a whole sphere, the size of the body section 2 is made small. Hence, only the heat dissipation through the body section 2 may fail to achieve a sufficient cooling effect.

FIGS. 3A and 3B are schematic views for illustrating the relationship between the shape of the globe and the light distribution angle.

More specifically, FIG. 3A shows the case where the globe 15 is shaped like a hemisphere. FIG. 3B shows the case where the shape of the globe 25 is close to a whole sphere.

The arrows in the figures indicate the traveling direction of light. Here, to avoid complexity, typical directions necessary for describing the light distribution angle are depicted.

In view of replacement for existing incandescent lamps, the outline dimension of the lighting device 1 is preferably as close to that of the incandescent lamp as possible. Thus, in FIGS. 3A and 3B, the diameter dimension D of the globes 15, 25 and the height dimension H of the lighting device are made nearly equal to the dimensions of their counterparts of the incandescent lamp.

As shown in FIG. 3B, if the shape of the globe 25 is made close to a whole sphere, light can be radiated further backward than for the hemispherical globe 15 shown in FIG. 3A. Thus, the light distribution angle can be expanded.

However, if the shape of the globe 25 is made close to a whole sphere, the height dimension H1b of the globe 25 is made larger than the height dimension H1a of the globe 15. On the other hand, the height dimension H of the lighting device is fixed. Hence, the height dimension H2b of the body section 22 is made smaller than the height dimension H2a of the body section 12. That is, if the shape of the globe 5 is made close to a whole sphere to expand the light distribution angle, the size of the body section 2 is made smaller. This may make it difficult to perform heat dissipation through the body section 2.

As described above, in improving the basic performance of the lighting device such as increasing the luminous flux and expanding the light distribution angle, only the heat dissipation through the body section 2 may fail to achieve a sufficient cooling effect. Thus, in this embodiment, a heat transfer section 9 is provided to increase the amount of heat dissipation through the globe 5.

The heat transfer section 9 is in thermal contact with at least one of the inner surface of the globe 5 and the heat dissipation surface on the end portion 2a side of the body section 2.

In this case, as shown in FIGS. 1A and 2, the heat transfer section 9 is provided inside the globe 5. The heat transfer section 9 can be configured to include an end portion 9a (corresponding to an example of the first end portion) at least partly in thermal contact with the inner surface of the globe 5, an end portion 9b at least partly in thermal contact with the end portion 2a of the body section 2, an end portion 9c at least partly in thermal contact with the substrate 8, and an end portion 9d at least partly in thermal contact with the radiation surface 3a of the light source 3.

However, it is not necessary to provide all of the end portion 9b, the end portion 9c, and the end portion 9d. It is only necessary to provide at least one of them.

In this description, “thermal contact” means that heat is transferred between the heat transfer section 9 and the mating member by at least one of thermal conduction, convection, and radiation.

For instance, heat can be transferred by thermal conduction e.g. through contact with the heat transfer section 9. Alternatively, a small gap to the heat transfer section 9 can be provided to transfer heat by convection and radiation.

That is, the end portion 9a, the end portion 9b, the end portion 9c, and the end portion 9d of the heat transfer section 9 may be in contact with the mating member, or may be spaced therefrom to the extent that heat can be transferred.

In this case, by thermal conduction, the heat dissipation effect can be improved. Hence, the end portion 9a, the end portion 9b, the end portion 9c, and the end portion 9d of the heat transfer section 9 are preferably in contact with the mating member.

The thermal contact is not necessarily needed in the entire region of the end portions, but only needed in at least part of the end portions.

In this case, more preferably, the thermal contact is provided in as a large region as possible.

At least one of the end portion 2a of the body section 2, the substrate 8, and the radiation surface 3a of the light source 3 serves as a heat dissipation surface on the end portion 2a side of the body section 2. Hence, the heat transfer section 9 only needs to be provided with an end portion (corresponding to an example of the second end portion) at least partly in thermal contact with at least one of these heat dissipation surfaces.

Furthermore, a bonding section 80 including a material having high thermal conductivity can be provided between at least part of the end portions 9b, 9c, 9d and the heat dissipation surface on the end portion 2a side.

For instance, the end portion 2a of the body section 2 and the end portion 9b can be bonded with e.g. solder to provide a bonding section 80. Furthermore, for instance, the substrate 8 and the end portion 9c can be bonded with e.g. solder to provide a bonding section 80. Furthermore, for instance, the radiation surface 3a of the light source 3 and the end portion 9d can be bonded with e.g. a heat transfer adhesive added with ceramic filler or metal filler having high thermal conductivity to provide a bonding section 80.

Furthermore, a bonding section 80 including a material having high thermal conductivity can be provided between the inner surface of the globe 5 and the end portion 9a.

The inner surface of the globe 5 and the end portion 9a can be bonded with e.g. a heat transfer adhesive added with ceramic filler or metal filler having high thermal conductivity to provide a bonding section 80.

The end portion of the heat transfer section 9 may be brought into thermal contact with the mating side simply by contact therebetween. However, if the end portion of the heat transfer section 9 and the mating side are bonded via a bonding section 80 including a material having high thermal conductivity, the thermal resistance can be decreased. Hence, the cooling effect described later can be improved.

Here, a gap may occur in bonding the end portion of the heat transfer section 9 and the mating side. Such a gap increases the thermal resistance. Hence, even in the case where a gap occurs, by bonding via a bonding section 80, the thermal resistance can be decreased.

The heat transfer section 9 can be formed from a material having high thermal conductivity. For instance, the heat transfer section 9 can be formed from e.g. a metal such as aluminum (Al), copper (Cu), and an alloy thereof. However, the material of the heat transfer section 9 is not limited thereto. The heat transfer section 9 can also be formed from e.g. an inorganic material such as aluminum nitride (AlN), aluminum oxide (Al₂O₃) or an organic material such as high thermal conductivity resin.

Here, if the heat transfer section 9 is simply provided inside the globe 5, the difference between the light portion and the dark portion occurring on the globe 5 is increased. This may increase the brightness unevenness in the lighting device 1. Thus, the heat transfer section 9 is configured to be able to reflect the light radiated from the light source 3.

In this case, for instance, the heat transfer section 9 can be configured to have higher reflectance than the globe 5.

For instance, the heat transfer section 9 can be configured to include a reflective layer 60 on its surface.

The reflective layer 60 can be e.g. a layer formed by application of a white paint. In this case, the paint used for white paint application is preferably resistant to heat generated in the lighting device 1 and resistant to light radiated from the light source 3. Such a paint can be e.g. a polyester resin-based white paint, acrylic resin-based white paint, epoxy resin-based white paint, silicone resin-based white paint, or urethane resin-based white paint including at least one or more white pigments such as titanium oxide (TiO₂), zinc oxide (ZnO), barium sulfate (BaSO₄), and magnesium oxide (MgO), or a combination of two or more white paints selected therefrom.

In this case, a polyester-based white paint and a silicone resin-based white paint are more preferable.

However, the reflective layer 60 is not limited thereto. For instance, the reflective layer 60 can be formed from a metal having high reflectance such as silver and aluminum by a coating process such as plating, evaporation, and sputtering, or by a cladding process with a base material.

Alternatively, the heat transfer section 9 itself may be formed from a material having high reflectance.

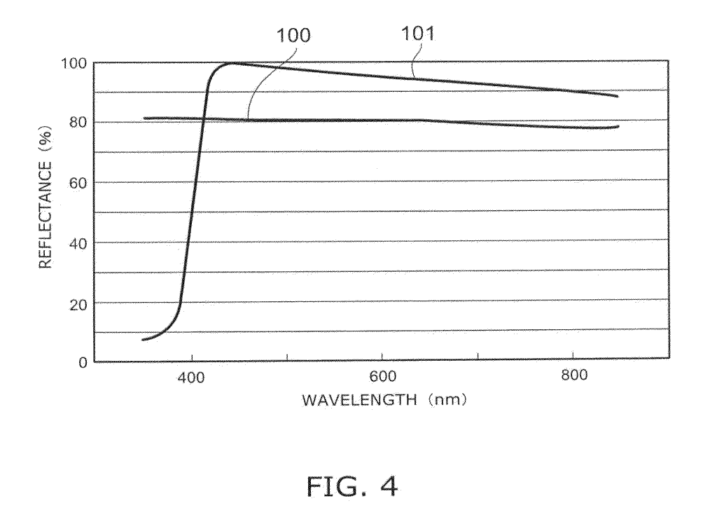

FIG. 4 is a graph for illustrating the reflectance of the reflective layer.

In FIG. 4, the numeral 100 indicates a reflective layer formed from a rolled plate of aluminum (A1050 specified by the JIS standard). The numeral 101 indicates a reflective layer formed by application of a polyester resin-based white paint.

In the case of providing a reflective layer 60 or forming the heat transfer section 9 itself from a material having high reflectance, it is preferable that the reflectance to light radiated from the light source 3 be made 90% or more, and it is more preferable that the reflectance be made 95% or more. In this description, the reflectance refers to that to light having a wavelength at least near 460 nm or near 570 nm.

Thus, more preferably, the reflective layer 60 is formed by application of a polyester resin-based white paint.

If the heat transfer section 9 is configured to be able to reflect the light radiated from the light source 3, the difference between the light portion and the dark portion occurring on the globe 5 can be decreased. This can decrease the brightness unevenness in the lighting device 1. Furthermore, the light distribution angle in the lighting device 1 can also be expanded.

The heat transfer section 9 can be configured to have a plate-like form, or an intersecting form of a plurality of plate-like bodies. For instance, the heat transfer section 9 illustrated in FIGS. 1A, 1B, and 2 has a crossed form of two plate-like bodies.

Furthermore, the heat transfer section 9 can be configured to have a form with rotational symmetry about the optical axis of the lighting device 1.

Here, as in the example illustrated in FIGS. 1A and 1B, in the case where, in plan view, the center of one end portion 2a of the body section 2 is aligned with the center of the light source 3, the central axis 1a of the lighting device 1 coincides with the optical axis of the lighting device 1.

Thus, in the lighting device 1 illustrated in FIGS. 1A and 1B, the heat transfer section 9 can be configured to have a form with rotational symmetry about the central axis 1a of the lighting device 1.

If the heat transfer section 9 is configured to have a form with rotational symmetry about the optical axis of the lighting device 1, the brightness in the respective regions defined by the heat transfer section 9 can be made equivalent to each other.

Thus, the difference between the light portion and the dark portion occurring on the globe 5 can be decreased. This can decrease the brightness unevenness in the lighting device 1.

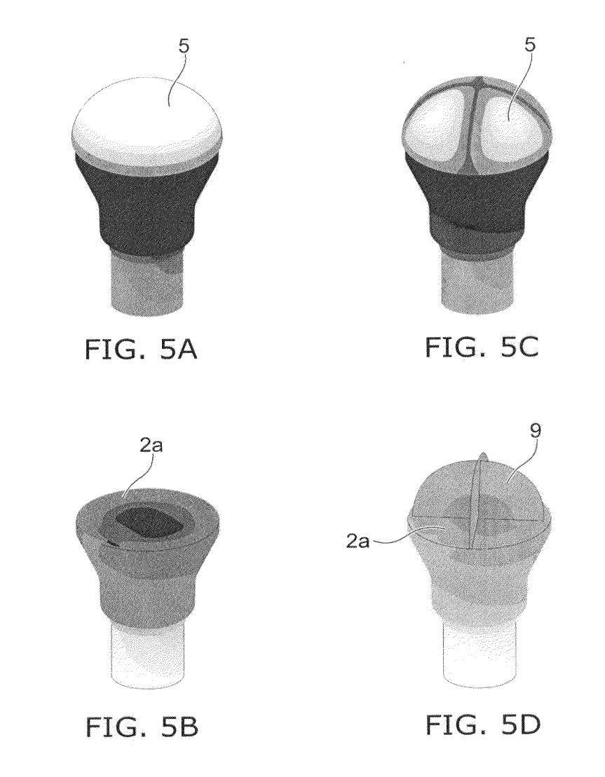

FIGS. 5A to 5D are schematic views for illustrating heat dissipation in the lighting device.

More specifically, FIG. 5A is a schematic view for illustrating the temperature distribution in the case where the heat transfer section 9 is not provided. FIG. 5B is a schematic view for illustrating the temperature distribution near the end portion 2a of the body section 2 in the case where the heat transfer section 9 is not provided. FIG. 5C is a schematic view for illustrating the temperature distribution in the case where the heat transfer section 9 is provided. FIG. 5D is a schematic view for illustrating the temperature distribution near the heat transfer section 9 in the case where the heat transfer section 9 is provided.

FIGS. 5A to 5D show the temperature distributions of the lighting device determined by simulation, with the output of the light source 3 set to approximately 5 W (watts), and the ambient temperature set to approximately 25° C.

In FIGS. 5A to 5D, the temperature distribution is represented by monotone shading, with a higher temperature shaded darker, and a lower temperature shaded lighter.

As shown in FIG. 5B, in the case where the heat transfer section 9 is not provided, the temperature near the end portion 2a of the body section 2 is increased.

In this case, as shown in FIG. 5A, the surface temperature of the globe 5 is decreased.

That is, it is found that in the case where the heat transfer section 9 is not provided, heat generated in the light source 3 is dissipated to the outside through the substrate 8 and the body section 2, and the heat is not transmitted to the globe 5 side.

On the other hand, as seen in FIG. 5C, in the case where the heat transfer section 9 is provided, the surface temperature of the globe 5 is increased around the portion where the heat transfer section 9 is in thermal contact with the globe 5.

In this case, as shown in FIG. 5D, the heat generated in the light source 3 can be transmitted to the globe 5 by the heat transfer section 9. Hence, the temperature in the end portion 2a of the body section 2 can be decreased. Thus, by providing the heat transfer section 9 illustrated in FIGS. 1A and 1B, the temperature in the end portion 2a of the body section 2 can be decreased. This can suppress the temperature increase of the light emitting element 3b.

According to this embodiment, heat can be dissipated also from the globe 5 through the heat transfer section 9. Hence, the heat dissipation performance of the lighting device 1 can be improved. Thus, the lifetime of the lighting device 1 can be prolonged. Furthermore, the basic performance of the lighting device 1 can be improved, such as increasing the luminous flux and expanding the light distribution angle.

Furthermore, if the heat transfer section 9 is configured to be able to reflect the light radiated from the light source 3, the difference between the light portion and the dark portion occurring on the globe 5 can be decreased. This can decrease the brightness unevenness in the lighting device 1.

Furthermore, if the heat transfer section 9 is configured to have a form with rotational symmetry about the optical axis of the lighting device 1, the difference between the light portion and the dark portion occurring on the globe 5 can be decreased. This can decrease the brightness unevenness in the lighting device 1.

### Second Embodiment

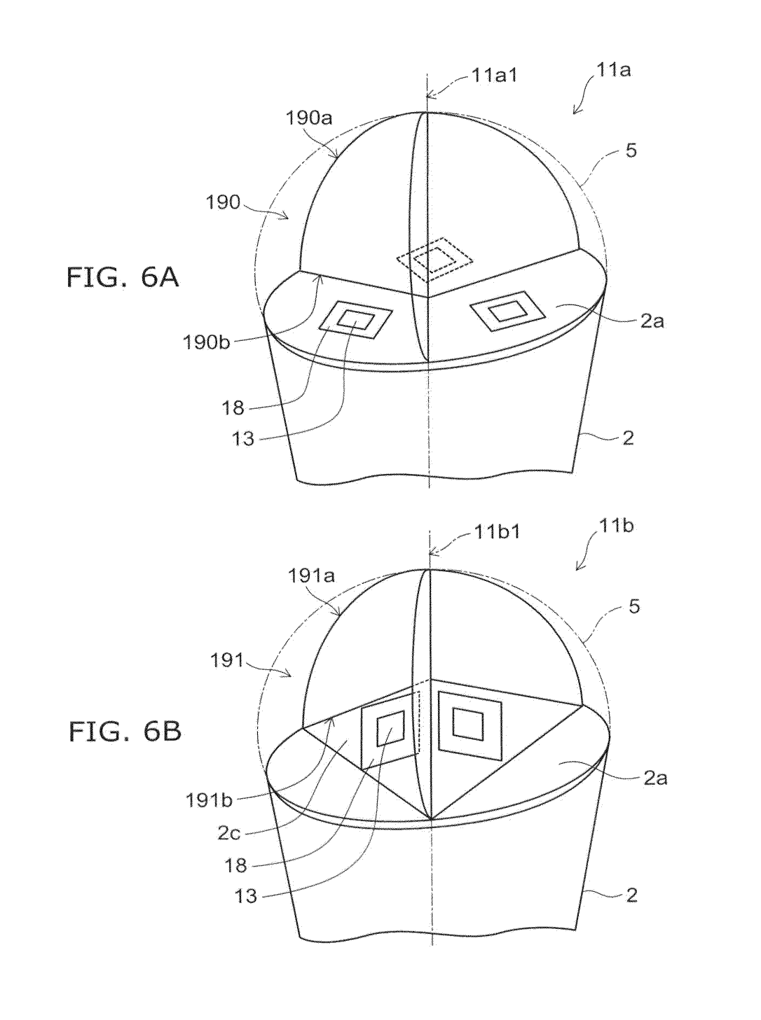

FIGS. 6A and 6B are schematic perspective views for illustrating lighting devices according to a second embodiment.

More specifically, FIG. 6A is a schematic perspective view for illustrating a heat transfer section with light sources arranged two-dimensionally. FIG. 6B is a schematic perspective view for illustrating a heat transfer section with light sources arranged three-dimensionally.

As shown in FIGS. 6A and 6B, the lighting device 11a, 11b includes a body section 2, light sources 13, a globe 5, and a heat transfer section 190, 191. Furthermore, like the lighting device 1 described above, the lighting device 11a, 11b includes a base section 6 and a control section 7, although not shown.

This embodiment is different from that illustrated in FIGS. 1A, 1B, and 2 in the arrangement of the light sources 13.

As shown in FIG. 6A, in the lighting device 11a, three light sources 13 are provided on the end portion 2a of the body section 2 via a substrate 18. In this case, the light sources 13 are provided at respective positions with rotational symmetry about the central axis 11a1 of the lighting device 11a.

As shown in FIG. 6B, in the lighting device 11b, a protrusion 2c is provided on the end portion 2a of the body section 2.

The protrusion 2c is shaped like a regular triangular pyramid. On its respective slopes, light sources 13 are provided via a substrate 18. In this case, the light sources 13 are provided at respective positions with rotational symmetry about the central axis 11b1 of the lighting device 11b.

The peak of the protrusion 2c is provided at the position where the central axis 11b1 of the lighting device 11b passes.

In the lighting device 11b shown in FIG. 6B, the light source 13 is provided on the slope of the protrusion 2c. Hence, the optical axis of each light source 13 crosses the central axis 11b1 of the lighting device 11b. However, the light sources 13 are provided at respective positions with rotational symmetry about the central axis 11b1 of the lighting device 11b. Hence, the central axis 11b1 of the lighting device 11b coincides with the optical axis of the lighting device 11b.

The protrusion 2c can be formed from e.g. a material having high thermal conductivity. For instance, the protrusion 2c can be formed from e.g. a metal such as aluminum (Al), copper (Cu), and an alloy thereof. However, the material of the protrusion 2c is not limited thereto. The protrusion 2c can also be formed from e.g. an inorganic material such as aluminum nitride (AlN), aluminum oxide (Al₂O₃) or an organic material such as high thermal conductivity resin. In this case, the protrusion 2c and the body section 2 can be formed from the same material, or can be formed from different materials. Furthermore, the protrusion 2c and the body section 2 can be integrally formed, or can be bonded via a material having high thermal conductivity.

Like the light source 3, the light source 13 can be configured to include one or more light emitting elements 3b. Here, the number of light emitting elements 3b can be appropriately modified depending on e.g. the purpose of the lighting device 11a, 11b and the size of the light emitting element 3b. In the example illustrated in FIG. 6B, the light sources 13 are provided on the three slopes, one for each, of the protrusion 2c shaped like a regular triangular pyramid.

Like the substrate 8, the substrate 18 can be formed from e.g. a material having high thermal conductivity. The substrate 18 can be formed from e.g. a metal such as aluminum (Al), copper (Cu), and an alloy thereof. A wiring pattern, not shown, can be formed on the surface of the substrate 18 via an insulating layer.

The heat transfer section 190 provided in the lighting device 11a shown in FIG. 6A is provided inside the globe 5. The heat transfer section 190 can be configured to include an end portion 190a at least partly in thermal contact with the inner surface of the globe 5, and an end portion 190b at least partly in thermal contact with the end portion 2a of the body section 2. Here, the end portion 190a corresponds to the end portion 9a of the heat transfer section 9 described above. The end portion 190b corresponds to the end portion 9b of the heat transfer section 9 described above. Furthermore, depending on the size and shape of the substrate 18, the heat transfer section 190 can also include an end portion corresponding to the end portion 9c of the heat transfer section 9 described above.

The heat transfer section 191 provided in the lighting device 11b shown in FIG. 6B is provided inside the globe 5. The heat transfer section 191 can be configured to include an end portion 191a at least partly in thermal contact with the inner surface of the globe 5, and an end portion 191b at least partly in thermal contact with the protrusion 2c. In this case, the end portion 191b may be in thermal contact with the end portion 2a of the body section 2.

Here, the end portion 191a corresponds to the end portion 9a of the heat transfer section 9 described above. The protrusion 2c can be thermally regarded as part of the end portion 2a of the body section 2. Hence, the end portion 191b corresponds to the end portion 9b of the heat transfer section 9 described above.

Furthermore, depending on the size and shape of the substrate 18, the heat transfer section 191 can also include an end portion corresponding to the end portion 9c of the heat transfer section 9 described above.

The end portion of the heat transfer section 190, 191 may be brought into thermal contact with the mating side simply by contact therebetween. However, if the end portion of the heat transfer section 190, 191 and the mating side are bonded via a bonding section 80 including a material having high thermal conductivity, the thermal resistance can be decreased. Hence, the cooling effect can be improved.

For instance, similarly to the heat transfer section 9 described above, the end portion of the heat transfer section 190, 191 and the mating side can be bonded with e.g. solder or a heat transfer adhesive added with ceramic filler, or metal filler having high thermal conductivity to provide a bonding section 80.

The material, reflectance and the like of the heat transfer section 190, 191 can be made similar to those of the heat transfer section 9 described above.

The heat transfer section 190, 191 can be configured to have a plate-like form, or an intersecting form of a plurality of plate-like bodies. For instance, the heat transfer section 190, 191 illustrated in FIGS. 6A and 6B has an intersecting form of three plate-like bodies. The light sources 13 are respectively provided in three regions defined by the plate-like bodies.

Furthermore, the heat transfer section 190, 191 can be configured to have a form with rotational symmetry about the optical axis of the lighting device 11a, 11b.

Here, as described above, the central axis 11a1, 11b1 of the lighting device 11a, 11b coincides with the optical axis of the lighting device 11a, 11b. Hence, the heat transfer section 190, 191 can also be configured to have a form with rotational symmetry about the central axis 11a1, 11b1 of the lighting device 11a, 11b.

If the heat transfer section 190, 191 is configured to have a form with rotational symmetry about the optical axis of the lighting device 11a, 11b, the brightness in the respective regions defined by the heat transfer section 190, 191 can be made equivalent to each other.

Thus, the difference between the light portion and the dark portion occurring on the globe 5 can be decreased. This can decrease the brightness unevenness in the lighting device 11a, 11b.

This embodiment can also achieve effects similar to those of the lighting device 1 described above.

Furthermore, in the lighting device 11b, the optical axis of each light source 13 crosses the central axis 11b1 of the lighting device 11b. Hence, the light distribution angle can be expanded.

Furthermore, in the three-dimensional arrangement of the light sources 13 as in the lighting device 11b, the number of light emitting elements provided therein can be made larger than in the two-dimensional arrangement of the light sources 13 as in the lighting device 11a.

Next, the heat transfer section is further illustrated.

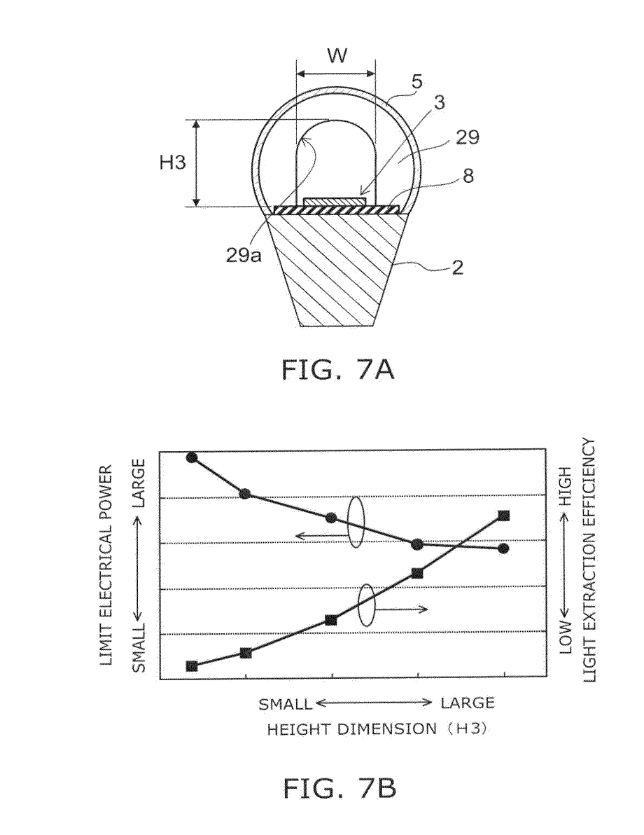

FIGS. 7A and 7B are schematic view and graph for illustrating a heat transfer section including an opening.

More specifically, FIG. 7A is a schematic partial sectional view for illustrating a heat transfer section including an opening. FIG. 7B is a schematic graph for illustrating the effect of providing an opening.

As shown in FIG. 7A, the heat transfer section 29 includes an opening 29a with height dimension H3.

The heat transfer section 29 includes an opening 29a penetrating in its thickness direction.

Here, for instance, as in the example illustrated in FIGS. 1A and 1B, the light source 3 can be provided on the end portion 2a of the body section 2. Then, the heat transfer section 29 is provided at the position blocking the light radiated from the light source 3.

In this case, by providing an opening 29a, blocking of the light radiated from the light source 3 can be suppressed.

For instance, as shown in FIG. 7B, by increasing the height dimension H3 of the opening 29a, the light extraction efficiency can be increased. Here, FIG. 7B illustrates the case of changing the height dimension H3 of the opening 29a. However, the same applies to the case of changing the width dimension W of the opening 29a. That is, also by increasing the width dimension W of the opening 29a, the light extraction efficiency can be increased.

However, if an excessively large opening 29a is provided, then the amount of heat transfer, and hence the amount of heat dissipation, by the heat transfer section 29 is decreased. This may decrease the amount of light radiated from the light source 3.

For instance, as shown in FIG. 7B, if the height dimension H3 of the opening 29a is increased, the amount of heat dissipation by the heat transfer section 29 is decreased. This decreases the limit electrical power (the electrical power which can be inputted to the light emitting element 3b). Then, if the limit electrical power is decreased, the amount of light radiated from the light source 3 is decreased.

Thus, the size of the opening 29a can be appropriately determined by taking into consideration the characteristics of the light emitting element 3b, the increase of light extraction efficiency due to the provision of the opening 29a, and the decrease of heat dissipation due to the provision of the opening 29a.

Furthermore, FIG. 7A illustrates the opening 29a which opens in the periphery on the body section 2 side of the heat transfer section 29. However, the shape of the opening 29a and the position for providing the opening 29a can be appropriately modified.

However, the light extraction efficiency can be increased by providing the opening 29a at a position closer to the light source 3. Hence, as illustrated in FIG. 7A, the opening 29a is preferably configured so as to open in the periphery on the body section 2 side of the heat transfer section.

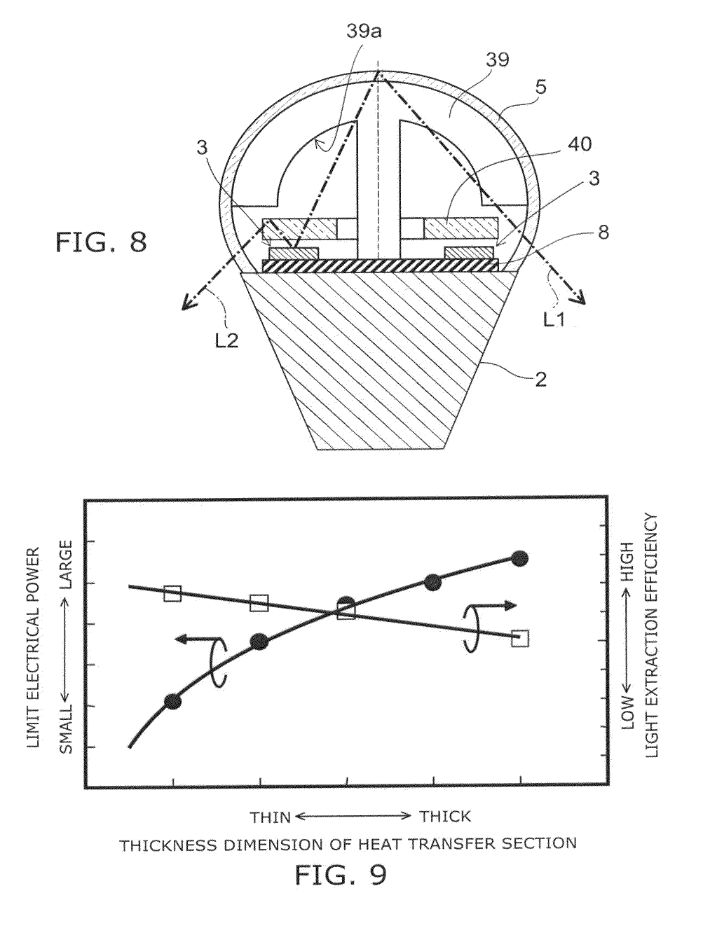

FIG. 8 is a schematic partial sectional view for illustrating an opening according to an alternative embodiment.

As shown in FIG. 8, the opening 39a provided in the heat transfer section 39 opens in the end portion on the body section 2 side and the end portion on the globe 5 side of the heat transfer section 39. The heat transfer section 39 is in contact with the substrate 8 on the center side and extends to the globe 5 side. Near the globe 5, the heat transfer section 39 extends outward from the axis of the lighting device along the globe shape. The cross section of the heat transfer section 39 including the axis of the lighting device is shaped like an umbrella. Here, the propagation and reflection of part of the light emitted from the light source 3 in the globe 5 are projected on the cross section of FIG. 8 and represented by dot-dashed lines (light L1, L2).

In this case, the opening 39a opens in the periphery on the globe 5 side of the heat transfer section 39. Thus, as shown in FIG. 8, the light L1 emitted from the light source 3 and reflected at the globe inner surface, and the light L2 reflected at the end surface of the lens 40, are radiated to the backward direction of the lighting device. Hence, the light extraction efficiency can be increased, and the light distribution angle can be expanded.

In this heat transfer section 39, the left half plate-like body and the right half plate-like body in FIG. 8 are integrally formed. These two plate-like bodies are connected, for instance, at the position indicated by the dashed line of FIG. 8.

Alternatively, in the heat transfer section 39, the left half plate-like body and the right half plate-like body in FIG. 8 may be separately formed and coupled on the dashed line of FIG. 8.

To the heat transfer section 39, a separate plate-like body (not shown) may be further added. The added plate-like body crosses, or is connected to, the other plate-like bodies on the dashed line shown in FIG. 8, and constitutes part of the heat transfer section 39.

Furthermore, the light sources 3 can be arranged in a circular configuration. The light source 3 can also be provided near the globe 5.

Furthermore, as shown in FIG. 8, an optical element such as an annular lens 40 can be easily provided.

In this case, there is no particular limitation on the position where the opening 39a opens in the periphery on the globe 5 side of the heat transfer section 39.

However, as shown in FIG. 8, if the opening 39a is configured to open at a position closer to the body section 2, the light extraction efficiency can be further increased, and the light distribution angle can be further expanded.

As illustrated above, the opening can be configured to open in at least one of the periphery on the body section side of the heat transfer section and the periphery on the globe 5 side of the heat transfer section.

FIG. 9 is a schematic graph for illustrating the thickness dimension of the heat transfer section.

As shown in FIG. 9, if the thickness dimension of the heat transfer section is thickened, the light extraction efficiency is decreased. On the other hand, if the thickness dimension of the heat transfer section is thickened, the amount of heat dissipation by the heat transfer section is increased. This increases the limit electrical power. Then, if the limit electrical power is increased, the amount of light radiated from the light source 3 can be increased.

Furthermore, as described above, in view of replacement for existing incandescent lamps, the outline dimension of the lighting device is preferably as close to that of the incandescent lamp as possible. This results in restricting the size of the region for arranging the light source 3 and the heat transfer section. Thus, if the thickness dimension of the heat transfer section is made too thick, the number of light emitting elements 3b may be decreased. Furthermore, if the thickness dimension of the heat transfer section is made too thick, the light extraction efficiency may be decreased.

Furthermore, if the thickness dimension of the heat transfer section is made too thin, manufacturing of the heat transfer section may be made difficult. In this case, the heat transfer section can be manufactured by e.g. the die cast method.

Thus, the thickness dimension of the heat transfer section is preferably determined by taking into consideration the amount of heat dissipation by the heat transfer section, the size of the region for arranging the light source 3 and the heat transfer section, and the manufacturability of the heat transfer section.

According to the knowledge obtained by the inventors, the thickness dimension of the heat transfer section can be set to 0.5 mm or more and 5 mm or less. Then, the amount of heat dissipation by the heat transfer section, the size of the region for arranging the light source 3 and the heat transfer section, and the manufacturability of the heat transfer section can be all taken into consideration. Furthermore, if the thickness dimension of the heat transfer section is set to 0.5 mm or more and 5 mm or less, the light extraction efficiency can be made 90% or more.

The amount of heat transfer, and hence the amount of heat dissipation, in the heat transfer section can be increased by decreasing the thermal resistance in the connecting portion between the heat transfer section and the component provided on the body section 2 side.

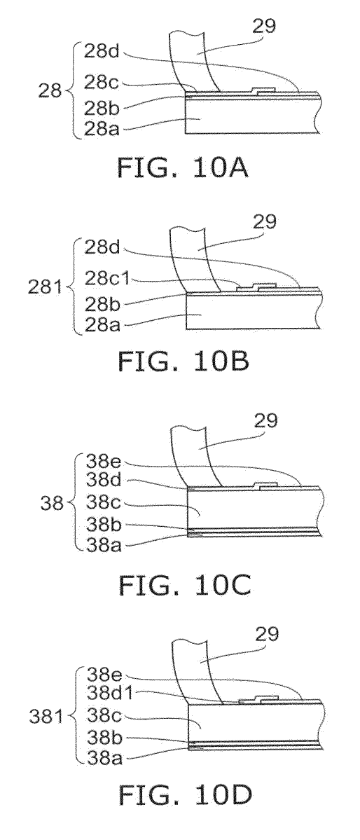

FIGS. 10A to 10D are schematic views for illustrating connecting portions between the heat transfer section and the substrate. Here, FIGS. 10A and 10C show the case where the reduction of thermal resistance is not taken into consideration. FIGS. 10B and 10D show the case where the thermal resistance is reduced.

As shown in FIG. 10A, the substrate 28 includes a base portion 28a formed from e.g. aluminum or copper, an insulating portion 28b provided on the base portion 28a, a solder resist portion 28c provided on the insulating portion 28b, and a wiring portion 28d provided on the insulating portion 28b. That is, the substrate 28 is a so-called metal base substrate.

The solder resist portion 28c can be formed by using e.g. the printing method or photographic method to apply a solder resist made of e.g. resin.

However, because the solder resist portion 28c is formed from a solder resist made of e.g. resin, the thermal resistance in the connecting portion between the heat transfer section 29 and the substrate 28 is increased.

In contrast, as shown in FIG. 10B, the substrate 281 includes a base portion 28a, an insulating portion 28b provided on the base portion 28a, a solder resist portion 28c1 provided on the insulating portion 28b, and a wiring portion 28d provided on the insulating portion 28b.

In this case, the solder resist portion 28c1 is not provided in the connecting portion between the heat transfer section 29 and the substrate 281, but the heat transfer section 29 is connected to the insulating portion 28b. Thus, the thermal resistance can be reduced by the amount of the solder resist portion 28c1.

Here, in forming the solder resist portion 28c1, it is possible to avoid forming the solder resist portion 28c1 in the region connected with the heat transfer section 29. Alternatively, the solder resist portion 28c1 can be formed by removing the solder resist in the region connected with the heat transfer section 29.

As shown in FIG. 10C, the substrate 38 includes a solder resist portion 38a, a wiring portion 38b provided on the solder resist portion 38a, an insulating portion 38c provided on the wiring portion 38b, a solder resist portion 38d provided on the insulating portion 38c, and a wiring portion 38e provided on the insulating portion 38c. That is, the substrate 38 is a so-called resin substrate.

The solder resist portion 38d can be formed by using e.g. the printing method or photographic method to apply a solder resist made of e.g. resin.

However, because the solder resist portion 38d is formed from a solder resist made of e.g. resin, the thermal resistance in the connecting portion between the heat transfer section 29 and the substrate 38 is increased.

In contrast, as shown in FIG. 10D, the substrate 381 includes a solder resist portion 38a, a wiring portion 38b provided on the solder resist portion 38a, an insulating portion 38c provided on the wiring portion 38b, a solder resist portion 38d1 provided on the insulating portion 38c, and a wiring portion 38e provided on the insulating portion 38c.

In this case, the solder resist portion 38d1 is not provided in the connecting portion between the heat transfer section 29 and the substrate 381, but the heat transfer section 29 is connected to the insulating portion 38c. Thus, the thermal resistance can be reduced by the amount of the solder resist portion 38d1.

Here, in forming the solder resist portion 38d1, it is possible to avoid forming the solder resist portion 38d1 in the region connected with the heat transfer section 29. Alternatively, the solder resist portion 38d1 can be formed by removing the solder resist in the region connected with the heat transfer section 29.

That is, the solder resist portion can be configured so that the solder resist portion formed from solder resist is not provided between the end portion of the heat transfer section 29 and the heat dissipation surface on the end portion 2a side of the body section 2.

The foregoing relates to the case of avoiding providing a member having high thermal resistance between the heat transfer section and the body section 2 side. However, the reduction of thermal resistance is not limited thereto.

For instance, a seat portion, not shown, can be provided on the body section 2 side of the heat transfer section to increase the contact area. Alternatively, the heat transfer section and the body section 2 side can be brought into close contact with each other by e.g. screw fastening. Alternatively, a high thermal conductivity metal, for instance, can be provided between the heat transfer section and the body section 2 side. Thus, the thermal resistance can be reduced. In this case, a gap may occur between the heat transfer section and the body section 2 side. However, a high thermal conductivity metal, for instance, provided between the heat transfer section and the body section 2 side can be used as a buffer and also serve to reduce the thermal resistance.

Next, the case of providing a diffusing portion on the surface of the heat transfer section is illustrated.

The diffusing portion is provided to diffuse light incident on the heat transfer section.

The diffusing portion can be configured as e.g. at least one of a projection provided on the surface of the heat transfer section and a diffusing layer 70 (see FIG. 1B) including a diffusing agent provided on the surface of the heat transfer section.

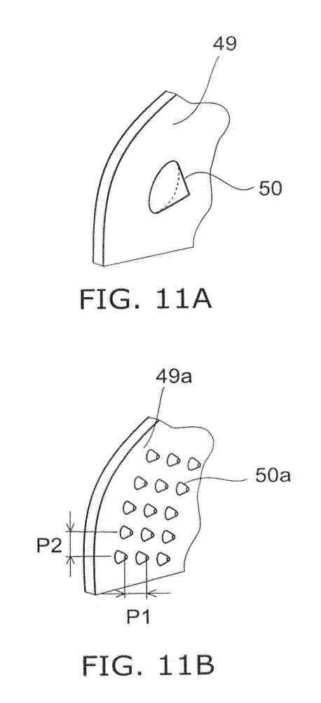

FIGS. 11A and 11B are schematic views for illustrating a projection provided on the surface of the heat transfer section.

More specifically, FIG. 11A shows the case where one projection is provided on the surface of the heat transfer section 49. FIG. 11B shows the case where a plurality of projections are provided on the surface of the heat transfer section 49a.

By providing a projection on the surface of the heat transfer section, the light incident on the heat transfer section can be diffused. If the light incident on the heat transfer section can be diffused, the light distribution angle can be expanded.

In this case, it is possible to provide one projection 50 on the surface of the heat transfer section 49 as shown in FIG. 11A. Alternatively, it is also possible to provide a plurality of projections 50a on the surface of the heat transfer section 49a as shown in FIG. 11B.

In the case of providing a plurality of projections 50a on the surface of the heat transfer section 49a, they can be provided in a regular arrangement pattern, or in an arbitrary arrangement pattern.

In the case of providing a plurality of projections 50a on the surface of the heat transfer section 49a, to avoid interference fringes, the pitch dimensions P1, P2 of the projections 50a are preferably set to 10 times or more of the wavelength of light radiated from the light source 3.

Here, the shape of the projection is not limited to those illustrated, but can be appropriately modified.

The foregoing relates to the case of diffusing the light incident on the heat transfer section by providing a projection on the surface of the heat transfer section. However, the light incident on the heat transfer section can also be diffused by providing a diffusing layer 70 on the surface of the heat transfer section.

The diffusing layer 70 can be e.g. a resin layer including a diffusing agent for diffusing light. Examples of the diffusing agent can include fine particles made of a metal oxide such as silicon oxide and titanium oxide, and fine polymer particles.

By providing a diffusing layer 70 on the surface of the heat transfer section, the light incident on the heat transfer section can be diffused. If the light incident on the heat transfer section can be diffused, the light distribution angle can be expanded.

Although FIGS. 11A and 11B show only one surface of the heat transfer section, the projection and the diffusing portion can be provided also on the other surface of the heat transfer section.

Next, the arrangement of the heat transfer section 59 and the light emitting element 3b as viewed from above the lighting device, i.e., the arrangement of the heat transfer section 59 and the light emitting element 3b in plan view, is illustrated.

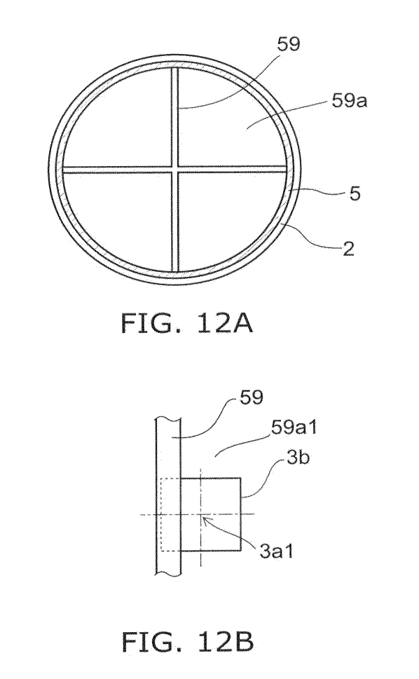

FIGS. 12A and 12B are schematic views for illustrating the arrangement of the heat transfer section 59 and the light emitting element 3b in plan view.

More specifically, FIG. 12A is a schematic view for illustrating the arrangement of the heat transfer section 59 and the light emitting element 3b in plan view. FIG. 12B is a schematic view for illustrating the positional relationship between the heat transfer section 59 and the light emitting element 3b in plan view.

As shown in FIG. 12A, by providing a heat transfer section 59, regions 59a defined by the heat transfer section 59 in plan view are formed.

In the case of providing a plurality of light emitting elements 3b, to suppress the light distribution unevenness and brightness unevenness, the number of light emitting elements 3b provided in each region 59a is preferably made equal. In this case, it is preferable to prevent the heat transfer section 59 and the light emitting elements 3b from overlapping in plan view.

However, according to the knowledge obtained by the inventors, even if there is a light emitting element 3b partly overlapping the heat transfer section 59 in plan view, the light distribution unevenness and brightness unevenness can be suppressed by preventing the heat transfer section 59 and the center 3a1 of the light emitting element 3b from overlapping.

In this case, it is only necessary that the number of light emitting elements 3b whose centers 3a1 are located in each region 59a defined by the heat transfer section 59 in plan view be made equal for each region 59a.

For instance, in FIG. 12B, the light emitting element 3b is regarded as a light emitting element provided in the region 59a1.

The heat transfer section preferably has a form with rotational symmetry about the optical axis of the lighting device or the central axis of the lighting device. However, the heat transfer section does not need to have a form with rotational symmetry if the number of light emitting elements 3b whose centers 3a1 are located in each region 59a defined by the heat transfer section 59 in plan view is equal for each region 59a.

The position where the light emitting element 3b is provided is not limited to the center side of the end portion 2a of the body section 2 (e.g., in the cases illustrated in FIGS. 1A, 1B, 6A, and 6B). For instance, the light emitting element 3b can also be provided on the periphery side of the end portion 2a of the body section 2, or on the entire region of the end portion 2a of the body section 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

For instance, the shape, dimension, material, arrangement, number and the like of the components included in e.g. the lighting device 1 and the lighting device 11 are not limited to those illustrated, but can be appropriately modified.

What is claimed is:

1. A lighting device comprising:
a body section;
a light source provided on one end portion of the body section and including a light emitting element;
a globe provided so as to cover the light source; and
a heat transfer section in thermal contact with at least one of an inner surface of the globe and a heat dissipation surface on the end portion side of the body section.

2. The device according to claim 1, wherein the heat transfer section includes a first end portion at least partly in thermal contact with the inner surface of the globe and a second end portion at least partly in thermal contact with the heat dissipation surface on the end portion side of the body section.

3. The device according to claim 1, wherein the heat transfer section includes an opening penetrating in thickness direction.

4. The device according to claim 3, wherein the opening opens in at least one of an end portion on the body section side of the heat transfer section and an end portion on the globe side of the heat transfer section.

5. The device according to claim 1, wherein the heat transfer section has a thickness dimension of 0.5 mm or more and 5 mm or less.

6. The device according to claim 1, wherein the heat transfer section has a higher reflectance than the globe.

7. The device according to claim 1, further comprising:
a reflective layer provided on a surface of the heat transfer section,
wherein reflectance of the reflective layer for light radiated from the light source is 90% or more.

8. The device according to claim 1, further comprising:
a diffusing portion provided on a surface of the heat transfer section and configured to diffuse light incident on the heat transfer section.

9. The device according to claim 8, wherein the diffusing portion is at least one of a projection provided on the surface of the heat transfer section and a diffusing layer including a diffusing agent provided on the surface of the heat transfer section.

10. The device according to claim 9, wherein
a plurality of the projections are provided, and
pitch dimension of the plurality of projections is 10 times or more of wavelength of light radiated from the light source.

11. The device according to claim 1, wherein
a plurality of the light emitting elements are provided, and
number of the light emitting elements whose centers are located in each region defined by the heat transfer section in plan view is equal for each region.

12. The device according to claim 1, wherein the heat transfer section has a form with rotational symmetry about at least one of optical axis of the lighting device and central axis of the lighting device.

13. The device according to claim 2, further comprising:
a bonding section provided between at least part of the first end portion and the inner surface of the globe.

14. The device according to claim 13, the bonding section includes at least one of ceramic filler and metal filler.

15. The device according to claim 2, further comprising:
a bonding section provided between at least part of the second end portion and the heat dissipation surface on the end portion side of the body section.

16. The device according to claim 15, wherein the bonding section provided between at least part of the second end portion and the heat dissipation surface on the end portion side of the body section includes at least one of ceramic filler and metal filler, or solder.

17. The device according to claim 2, wherein a solder resist portion formed from solder resist is not provided between at least part of the second end portion and the heat dissipation surface on the end portion side of the body section.

18. The device according to claim 1, wherein the heat transfer section includes at least one selected from the group consisting of aluminum, aluminum alloy, copper, copper alloy, aluminum nitride, aluminum oxide, and high thermal conductivity resin.

19. The device according to claim 1, further comprising:
a protrusion provided on the end portion of the body section,
wherein the protrusion includes a slope crossing central axis of the lighting device, and
the light source is provided on the slope.
